(19) United States
(12) Patent Application Publication
(10) Pub. No.: US 2017/0011713 A1
(43) Pub. Date: Jan. 12, 2017

(54) IMAGE OUTPUTTING DEVICE

(71) Applicant: Acer Incorporated, New Taipei City (TW)

(72) Inventor: Wen-Cheng Hsu, New Taipei City (TW)

(21) Appl. No.: 14/986,045

(22) Filed: Dec. 31, 2015

(30) Foreign Application Priority Data
Jul. 8, 2015 (TW) 104122114

(51) Int. Cl. G09G 5/12; G09G 5/08; G06F 3/0484; G06F 3/14

(52) U.S. Cl. CPC G09G 5/12; G06F 3/1454; G09G 5/08; G06F 3/0484

(57) ABSTRACT

An image outputting device for transmitting an output image to a remote screen is provided, including a display engine, a display, a position detection device, a processor and a transmission interface. The display engine provides a display frame. The display displays the display frame. The position detection device detects position information of an object corresponding to the display. The object is physically separated from the display. The processor generates the output image according to the position information and the display frame. The transmission interface transmits the output image to the remote screen.

### CROSS REFERENCE TO RELATED APPLICATIONS

This application claims priority of Taiwan Patent Application No. 104122114, filed on Jul. 8, 2015, the entirety of which is incorporated by reference herein.

### BACKGROUND OF THE INVENTION

Field of the Invention

The present invention relates to an image outputting device and more particularly to an image outputting device displaying images on a remote screen.

Description of the Related Art

As the popularity and the increasing capabilities of mobile devices, users can share the screen of the mobile device, such as cell phone or tablet, to a big remote screen via the screen sharing technology to get a better visual effect. However, if the user wants to control the mobile device via a touch control mechanism, the user needs to look at the display of the mobile device to execute functions, which corresponds to the touch position on the display. The user needs to switch his view on the mobile device and the big remote screen, and it is inconvenient to the user. Therefore, we need an image outputting device to improve the user experience of using the remote screen for displaying screen of the mobile device.

### BRIEF SUMMARY OF THE INVENTION

An embodiment of the invention provides an image outputting device for transmitting an output image to a remote screen. The image outputting device includes a display engine, a display, a position detection device, a processor and a transmission interface.

The display engine provides a display frame. The display displays the display frame. The position detection device detects position information of an object corresponding to the display. The object is physically separated from the display. The processor generates the output image according to the position information and the display frame. The transmission interface transmits the output image to the remote screen.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a functional block diagram of an image outputting device according to an embodiment of the invention.

FIG. 2 is a schematic diagram showing relation between a display frame F and a remote frame G.

FIG. 3 is a functional block diagram of an image outputting device according to another embodiment of the invention.

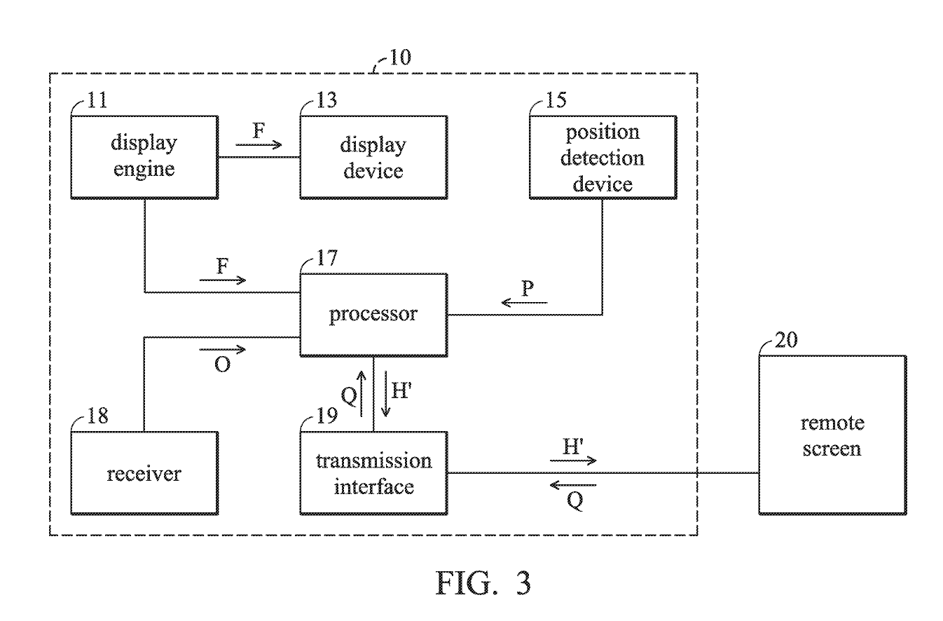

FIG. 4 is a schematic diagram showing relation between a display frame G and a remote frame G′.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

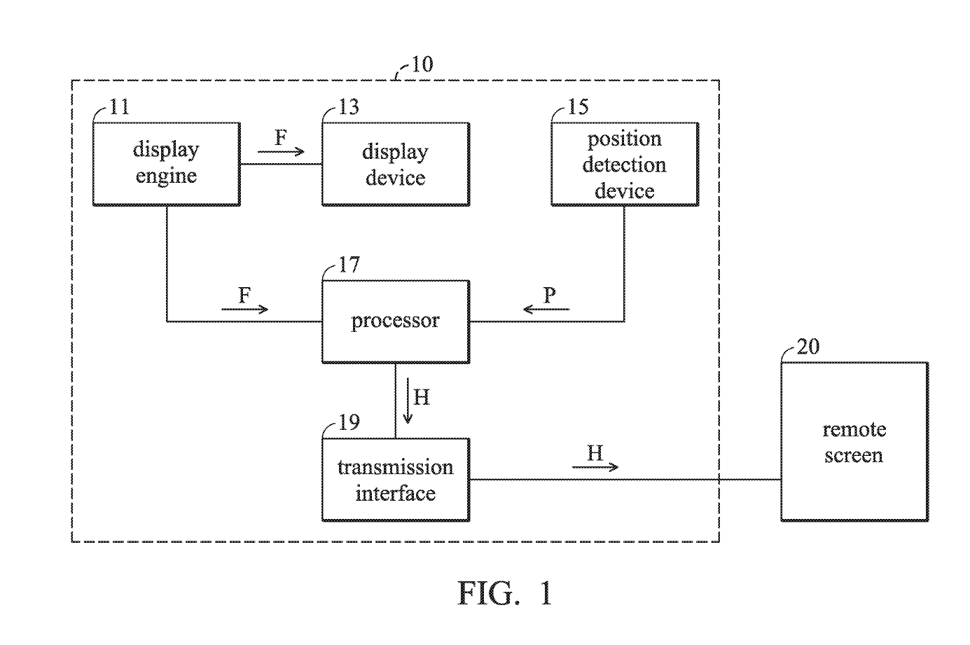

FIG. 1 is a functional block diagram of an image outputting device according to an embodiment of the invention. The image outputting device of FIG. 1 describes only necessary elements for implementing the embodiment, and other elements of the image outputting device, such as operation interface, communication module, memory module and speaker module, are well known by a person skilled in the art, and not be described here for briefly.

As shown in FIG. 1, an image outputting device 10 includes a display engine 11, a display device 13, a position detection device 15, a processor 17 and a transmission interface 19. According to an embodiment of the invention, the image outputting device 10, the image outputting device 10 may be a portable electronic device, such as a smart phone, a personal digital assistant (PDA), a palmtop computer, a tablet, a handheld game console or game stick. The image outputting device 10 is not limited to the described examples, and any electronic device with display can be embodiments of the image outputting device 10.

The display engine 10 provides a display frame F. According to an embodiment of the invention, the display frame F may be a desktop of a handheld game console, an operational interface of a specific application program, a game interface of a game console or an operation interface of game stick. The display device displays the display frame F. A According to embodiments of the invention, the display device 13 may be any type of display including liquid crystal display (LCD), plasma display panel (PDP), organic light emitting display (OLED), field emission display (FED) and light emitting diode (LED).

The position detection device 15 detects a position information P of an object corresponding to the display device. According to embodiments of the invention, the position detection device 15 detects the position information P when the object is physically separated from the display device 13. The object's position is at an area that the screen of display device 13 faces (in the following paragraph, it calls above the screen), and the object does not contact the screen of the display device 13. When the object is within an effective detection range of the position detection device 15, the position detection device 15 detects the position information P before the object does not contact the display device 13. The position information may be a projection position of the object with respect to the display screen of the display device 13. In other embodiments, the screen of the display device 13 can be divided into a plurality of sub-areas, and the position information P corresponds to one of the sub-areas. In other embodiments, the object may be user's finger, stylus or other handheld accessory, such as touch gloves.

According to embodiments of the invention, the position detection device 15 may be an image capture device, such as camera, and the position device 15 identifies position information of the object corresponding to the display device 13 by image identification technology or characteristic extraction technology. For example, the position detection device 15 estimates a corresponding position of the object on the display device according to the size or the angle of the object captured by the image capture device. The detail of the image processing technology to identify the object's position corresponding to the display device 13 is well known by people skilled in the art, and is not discussed here for briefly.

In another embodiment of the invention, the position device 15 includes a touch sensing module and is integrated with the display device 13. When the touch sensing module is integrated with the display device 13, the display device 13 is a touch display device. In this embodiment, the position device 15 uses a floating touch technology to detect the position information P of the object by the touch sensing module. The principle of the floating touch technology acquires sensing signals caused by capacitor effect generated on sensing electrode of the touch sensing module to determine a touch position. When the object approaches to the touch sensing module, the voltage of the electrode changes. Via the floating touch technology, the user need not to physically touch the touch panel, the position device 15 still can detect user's finger or handheld accessory. The effective detection distance of the floating touch technology is 15 mm. The other detail of the floating touch technology is well known by a person skilled in the art, and not be described here for briefly.

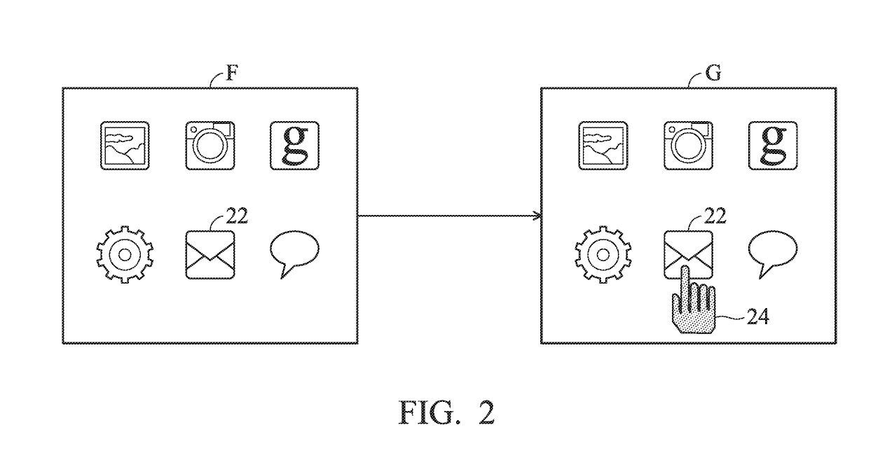

The processor 17 generates an output image according to the position information P from the position device 15 and the display frame F provided by the display engine, and the remote screen 20 display a remote frame G according to the display frame F. FIG. 2 is a schematic diagram showing relation between a display frame F and a remote frame G. Assuming the display frame F is a desktop screen of a cell phone, when the user's finger points the icon 22 but the user's finger does not physically touch the icon 22, the position of the user's finger is detected and the position information is then transmitted to the processor 17. When the processor 17 receives the position information P, the processor 17 generates a cursor 24 and combines the cursor 24 into a corresponding position of the display frame F to generate the output frame H. The remote screen 20 display the remote frame G according to the output frame H. The remote frame G comprises the display frame F and the cursor 24 corresponding to the position information P. In the remote frame G, the position of the cursor 24 corresponds to a projection position of the user's finger with respect to the display frame F of the display device 13. When the user's finger moves, the position device 15 also provides position information during the movement to the processor 17, and the processor generates a plurality of successive frames H dynamic showing the movement of the cursor 24. The remote frame G shown on the remote screen 20 also dynamic changes positions of cursor 24 on the remote screen 20.

In another embodiment, the image outputting device 10 comprises a receiver 18 connected to the processor 17. The processor 17 receives target frame 0 from other device via the receiver 18, receives resolution information Q of remote screen 20, combines the cursor 24 to the corresponding position of the target frame O according to the position information P and the resolution information Q to generate output frame H′ and transmits the output frame H′ to the remote screen 20. The remote screen 20 displays a remote frame G′ according to the output frame H′. The remote frame G′ comprises the target frame O and the cursor 24 on corresponding position. The display engine 11 generates corresponding control interface C according to the target frame O and corresponding operations, and the control interface C is display via the display engine 13 for the user to control the image outputting device 10.

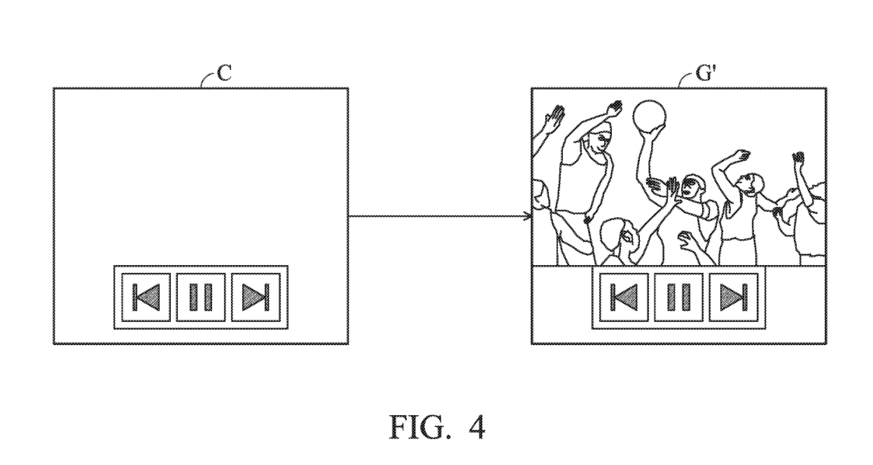

In FIG. 2 and FIG. 4, the cursor 24 is represented by a finger icon, but the form of the cursor 24 is not limited thereto. The cursor 24 can be represented by other pictures, light dot, dark dot or any object of gray level which is different from the display frame F. Any object that can identify the user's finger or the handheld accessory from the display device 13 can be used for embodiments of the proposed cursor 24.

When the processor 17 generates the output image H, the processor 17 transmits the output image H to the remote screen 20 via the transmission interface 10. The processor 17 transmits the output image H to the remote screen 20 via wired or wireless transmission mechanism. When the processor 17 transmits the output image H to remote screen 20 by wired transmission mechanism, the format of output image H is transformed into compatible format according to the type of the transmission interface 19, such as composite video connector, S-video, component Video Connector, VGA, digital visual interface (DVI), high definition multimedia interface (HDMI), and the transformed image is transmitted to the remote screen 20. When the processor 17 transmit the output image H to remote screen 20 by wireless transmission mechanism, the processor 17 uses one type of the wireless communication protocol, such as wireless wide area network (WWAN), wireless local area network (WLAN), wireless personal area network (WPAN), near field communication (NFC), Bluetooth, Wi-Fi Direct or Miracast, the processor 17 transmits the output frame H to the remote screen 20 via the transmission interface 19. Furthermore, according to embodiments of the invention, the remote screen 20 can be any device with display function, such as liquid crystal display (LCD), plasma display panel (PDP), organic light emitting display (OLED), field emission display (FED) and light emitting diode (LED). According to other embodiments, the processor 17 projects the output frame H to the remote screen 20 via the transmission interface 19, and the remote screen 20 may be an specific area for showing the projected output frame H, such as a wall or a scrim.

According to the technology disclosed by embodiments of the invention, the user needs not to check the display frame of the image outputting device 10 when the user transmits the display frame of the image outputting device 10 to the remote screen 20 via screen sharing technology or screen mirroring technology. The user needs not to check the screen of the image outputting device 10. The user just watches the remote screen 20 and can control the image outputting device 10 to execute corresponding operations. These operations are processed and implemented in the image outputting device 10, not the remote screen 20. The remote screen 20 only shows image transmitted from the image outputting device 10.

Assuming the image outputting device 10 is a smart phone executing action game program, the user can uses screen sharing technology or screen mirroring technology to transmit game screen to the big size remote screen 20 to get better game experience. Before the user touches the display 13 of the image outputting device 10, the user's finger or stylus is approaching to the display 13 of the image outputting device 10, a cursor 24 is shown on remote screen 20 to indicate a current position of the user's finger. The cursor 24 can avoid user touching wrong position and causing a wrong operation being activated accordingly. When the user watches cursor 24 on the remote screen 20 and confirms the finger's position, the user touches a corresponding user interface shown on the display 13 to control the image outputting device 10. Thus, the user can only watch the remote screen 20 without watching the display 13 to control the image outputting device 10 to get a better experience of screen sharing technology or screen mirroring technology.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image outputting device for transmitting an output image to a remote screen, comprising:
a display engine to provide a display frame;
a display device to display the display frame;
a position detection device to detect position information of an object corresponding to the display, wherein the object is physically separated from the display;
a processor to generate the output image according to the position information and the display frame; and
a transmission interface to transmit the output image to the remote screen.

2. The image outputting device as claimed in claim 1, wherein the processor generates a cursor according to the position information, and combines the cursor and the display frame to generate the output image.

3. The image outputting device as claimed in claim 1, wherein the remote screen displays a remote frame according to the output image, an the remote frame comprises the display frame and a cursor corresponding to the position information.

4. The image outputting device as claimed in claim 3, wherein a position, wherein the cursor is shown on the remote screen, corresponding to the position of the object on the display.

5. The image outputting device as claimed in claim 1, wherein the display frame comprises a user interface.

6. The image outputting device as claimed in claim 5, wherein the processor executes function corresponding to the user interface according to the position information.

7. The image outputting device as claimed in claim 1, wherein the transmission interface transmits the output image to the remote screen by a wireless transmission mechanism.

8. The image outputting device as claimed in claim 1, further comprising a receiver.

9. The image outputting device as claimed in claim 8, wherein the receiver receives a target image.

10. The image outputting device as claimed in claim 9, wherein the receiver receives resolution information of the remote screen.

11. The image outputting device as claimed in claim 10, wherein the processor generates a cursor according to the position information and the resolution information, and combines the cursor and the display frame to generate the output image.
